(19) United States
(12) Patent Application Publication
(10) Pub. No.: US 2026/0230828 A1
(43) Pub. Date: Aug. 6, 2026

(54) AUDIO POWER AMPLIFIER

(71) Applicant: POWERSOFT S.P.A., SCANDICCI (FIRENZE) (IT)

(72) Inventors: CLAUDIO LASTRUCCI, SCANDICCI (FIRENZE) (IT); LUCA LASTRUCCI, SCANDICCI (FIRENZE) (IT); FILIPPO DIGIUGNO, SCANDICCI (FIRENZE) (IT)

(21) Appl. No.: 19/149,340

(22) PCT Filed: Jan. 30, 2024
(86) PCT No.: PCT/IB2024/050835

§ 371 Date: Jul. 18, 2025

(30) Foreign Application Priority Data
Jan. 30, 2023 (IT) 102023000001413

(51) Int. Cl. H04W 12/47; H04L 9/32; H04W 12/71

(52) U.S. Cl. CPC H04W 12/47; H04L 9/3247; H04W 12/71

(57) ABSTRACT

An audio power amplifier, defining a plurality of characteristics pertaining to corresponding capabilities and functions of the audio amplifier itself, includes a control unit which includes instructions, where the instructions include setup parameters. The control unit is programmed for setting the characteristics of the plurality of characteristics according to setup parameter values; receiving digital information representing updating values for the plurality of setup parameters and updating the setting of the plurality of characteristics according to the updating values.

### TECHNICAL FIELD

This invention relates to an audio power amplifier. The disclosure also relates to a method for amplifying an audio signal through an audio power amplifier and to a method for varying the settings of an audio power amplifier.

### BACKGROUND ART

Audio amplifiers comprise a plurality of characteristics, pertaining to certain capabilities (such as output power rating or audio signal processing capacity) and to functions (such as number of digital input and output channels) of the audio amplifier itself.

Typically, the user (that is, a person forming part of the distribution network such as, for example, a distributor or an end customer) must be aware of the characteristics of the amplifier in order to be able to select the type of amplifier best suited for their requirements. There is therefore need to make amplifiers more flexible.

Patent document U.S. Pat. No. 10,382,268B1 relates to a method for configuring an electronic device through a configuration file; the document does not, however, explain how such a configuration can be produced for an audio amplifier.

### DISCLOSURE OF THE INVENTION

This disclosure has for an object to provide an audio power amplifier, a method for amplifying an audio signal through an audio power amplifier and a method for varying the settings of an audio power amplifier.

In particular, the aim of this disclosure is to provide an audio power amplifier, a method for amplifying an audio signal through an audio power amplifier and a method for varying the settings of an audio power amplifier capable of allowing easier and efficacious management of the sales network. A further aim of this disclosure is to propose an audio power amplifier, a method for amplifying an audio signal through an audio power amplifier and a method for varying the settings of an audio power amplifier capable of offering a bespoke solution to meet the needs of any user. Another aim of this disclosure is to provide an audio power amplifier, a method for amplifying an audio signal through an audio power amplifier and a method for varying the settings of an audio power amplifier with a focus on flexibility. These aims are fully achieved by the audio power amplifier, the method for amplifying an audio signal through an audio power amplifier and the method for varying the settings of an audio power amplifier according to this disclosure and as characterized in the appended claims.

In particular, the audio power amplifier defines a plurality of characteristics. The characteristics may be pertinent to corresponding capabilities of the amplifier (for example, maximum power of the output audio signal) and/or to functions of the amplifier (for example, number of digital input and/or output channels, type of signal processing algorithms).

Thus, the plurality of characteristics may comprise: a maximum power of the audio output signal from the amplifier; a number of enabled digital audio over IP input channels to the amplifier and/or a number of enabled digital audio over IP output channels from the amplifier), the audio amplifier being a multi-channel amplifier; a type of encryption of digital audio-over-IP input and/or output channels; one or more types of amplifier signal processing algorithms (or blocks); a signal processing capacity (for example, a number of filters); application functions, for example, the playing of audio files.

In particular, each block (or algorithm) may be enabled or disabled (that is, may be executed or not executed, that is to say, bypassed).

The audio amplifier comprises a control unit. The control unit includes instructions. The instructions include setup parameters. In particular, the instructions may be configured to allow enabling or disabling one or more characteristics of the plurality of characteristics, for example, enabling or disabling one or more amplifier functions (for example, enabling or disabling one or more types of signal processing algorithms). Alternatively, or in addition, the instructions may be configured to allow setting a size (or capacity) of one or more characteristics of the plurality of characteristics, for example, setting one or more capabilities of the amplifier (for example, setting a size of the maximum power of the audio output signal from the amplifier).

The control unit is programmed for setting the characteristics (or at least one characteristic) of the plurality of characteristics according to setup parameter values.

The control unit is programmed for receiving setup data, representing updating values for the plurality of setup parameters. The control unit is programmed for updating the setting of the characteristics (or at least one characteristic) of the plurality of characteristics according to the updating values.

Thus, the audio amplifier comprises (or defines) a Safety Operating Area (SoA) protection system. The SoA protection system defines conditions for safely operating the audio amplifier, in terms of voltage and current; in other words, the SoA protection system defines voltage and current value ranges within which the audio amplifier can operate without being damaged.

The SoA protection system may be an analogue system or a digital system or a system that is both analogue and digital.

In particular, through the SoA protection system and based on the updating data, the control unit may be programmed to limit the output voltage and/or current (that is, the power) for each channel of the audio amplifier. In particular, through the SoA protection system and based on the updating data, the control unit may be programmed to limit the input current.

For example, the audio amplifier may comprise an electronic card comprising a plurality of portions, or the audio amplifier may comprise a plurality of electronic cards comprising a corresponding plurality of portions. Electronic components of the amplifier may all be located on the same electronic card, or on different portions of the electronic card or on the plurality of electronic cards. In particular, the audio amplifier may comprise a single control unit, common to all the portions of the electronic card (or common to two or more portions of the electronic card), or one control unit for each portion of the electronic card (or for one or more portions of the electronic card).

In particular, the audio amplifier comprises a power unit and a portion dedicated to the electrical power supply of the audio amplifier. The portion dedicated to the electrical power supply may include a power unit controller.

The portion dedicated to the electrical power supply, that is, the power unit controller, may bring about (or adjust) the absorption of current on the power unit, for example, through an integrated microchip or an analogue circuit.

In particular, the audio amplifier comprises an electronic card dedicated to the power circuitry. The electronic card dedicated to the power circuitry and the portion dedicated to the electric power supply may be located on a shared electronic card (to carry out the power supply function and the power amplifying function).

In an example, the audio amplifier comprises an SoA controller, configured to implement the SoA protection system. The SoA controller may be programmed to set the characteristics of the audio amplifier. In particular, the SoA controller is programmed to define the values of output power delivered by the audio amplifier and/or to define the values of input current delivered to the audio amplifier. The SoA controller may be programmed to communicate with the power unit controller.

The control unit is programmed to communicate with the SoA controller. For example, the control unit can communicate with the SoA controller so as to supervise the settings received.

Preferably, the audio amplifier comprises a sensor system. The sensor system comprises an output current sensor, configured to detect an output current value for each channel, and an output voltage sensor, configured to detect an output voltage value for each channel. The sensor system may comprise a power supply current sensor configured to detect a value of power supply current. The sensor system may comprise a temperature sensor. The control unit, or the SoA controller, is programmed to receive the detected values. The control unit, or the SoA controller, may be programmed to check that the detected values match the set updating values. If the detected values fail to match the set updating values, the SoA controller may be configured to vary the output power from the audio amplifier and/or to vary the voltage input to the audio amplifier.

The audio amplifier may comprise a single memory, common to all the portions of the electronic card (or common to two or more portions of the electronic card), or one memory for each portion of the electronic card (or for one or more portions of the electronic card).

The instructions may be configured to allow enabling and/or disabling one or more characteristics of the plurality of characteristics and/or to allow setting a size of one or more characteristics of the plurality of characteristics, based on the setup data received. The setup data may include values to be assigned to the setup parameters. The values may include a binary value (relating to enabling or disabling of an audio amplifier function) and/or they may include a number (relating to a size of a capability).

It should be noted, in particular, that the instructions define a parametric software program, that is, a software program comprising parameters and configured to allow setting the parameters; in particular, based on setup data received, the control unit sets the parameters contained in the software to allow setting a characteristic of the audio amplifier.

Thus, the invention allows a user (for example, an end customer or a person forming part of the distribution chain) to define the characteristics of the amplifier, for example the moment it is used on site or the moment it is sold to the end customer.

In particular, according to the invention, the amplifier can vary some of the characteristics without having to physically modify the hardware, and is thus adaptable to the user's needs.

The possibility of characterizing the amplifier after it has been made facilitates, for example, warehouse management by a distributor or reseller and also allows an end customer to purchase an amplifier which can be adapted to their specific needs at a later stage.

In an example, the control unit comprises a memory. The memory includes a setup file. The control unit may be programmed to update the setup file based on the setup data received.

The setup file may comprise a digital signature (or the setup data may comprise a digital signature) and the control unit may be programmed to perform a check on the digital signature.

In particular, the control unit may be programmed to extract (that is, retrieve) the digital signature from the setup file (or from the setup data). The control unit may be programmed to check the digital signature through a public-key/private-key system. Following a positive result of the check on the digital signature, the control unit may be programmed to set the characteristics of the plurality of characteristics according to the values of the setup parameters and/or, in particular, to update the setting of the characteristics of the plurality of characteristics according to the updating values.

The setup file (or the updating data) may comprise a timestamp. The timestamp may relate to a time the setup file or the updating data was created or sent. The control unit may comprise a clock and may be programmed to perform a check on the timestamp. For example, the control unit may be programmed to check, before updating the values, that the time associated with the timestamp is prior to a given time.

The setup file or the setup data may be encrypted. The control unit may be programmed to decrypt them before updating the values.

In an example, the audio amplifier comprises a serial number uniquely assigned to the audio amplifier and accessible to the memory and the setup file (or the setup data) comprises the serial number. The control unit may be programmed to check that the serial number included in the setup file (or in the setup data) matches the serial number of the amplifier.

In particular, the control unit may be programmed to extract the serial number from the setup file or from the setup data to compare it with the serial number of the audio amplifier. If the result is positive, the control unit may be programmed to update the values.

Thus, a setup file or setup data, protected digitally (for example, through a digital signature, encryption, timestamp and/or serial number) is used to ensure the file or the data is authentic; this ensures that the audio amplifier uses only the characteristics effectively defined in the setup file or in the setup data, hence only the characteristics effectively purchased by the user. Alternatively or in addition to digitally protecting the setup file or the setup data, it is also possible for the setup file and/or the setup data to be received through a protected communication channel.

In an example, the audio amplifier comprises an NFC data exchange device and the control unit is programmed to receive the setup data through the data exchange device from a mobile device enabled to transfer data by NFC technology.

The use of NFC technology has the advantage of allowing the setup data to be received even when the amplifier is off (or still in its packaging); when the amplifier is next switched on, the values are updated.

In an embodiment, the audio amplifier comprises an Internet connecting channel and the control unit is programmed to receive the setup file through the Internet connecting channel and to decrypt the setup file. Preferably, the control unit receives the setup file in encrypted form. The control unit may update the values after receiving the setup file or it may update the values at a later stage.

For example, the control unit has a clock and is programmed to set the characteristics permanently or for a defined time interval according to instructions contained in the setup file. For example, the setup data may comprise a temporal instruction, representing the time interval for which the settings are valid.

This disclosure also provides a method for amplifying an audio signal through an audio power amplifier, where the audio power amplifier defines a plurality of characteristics pertaining to corresponding capabilities and/or functions of the audio amplifier itself, where the audio amplifier may be made according to one or more of the features described herein. Preferably, the amplifier comprises a control unit including instructions. The instructions include setup parameters. The method comprises a step, performed by the control unit, of setting the plurality of characteristics according to setup parameter values. The method comprises a step of receiving setup data, representing updating values for the plurality of setup parameters and updating the setting of the plurality of characteristics according to the updating values.

This disclosure also provides a method for varying the settings of an audio power amplifier, the audio power amplifier defining a plurality of characteristics pertaining to corresponding capabilities and/or functions of the audio amplifier itself, where the amplifier may be made according to one or more of the features described herein. The amplifier comprises a control unit, where the control unit includes instructions; the instructions comprise setup parameters. The method comprises a step of transmitting setup data, representing updating values for the setup parameters. The setup data are intended to be received and processed by the control unit to update the setting of the characteristics of the plurality of characteristics according to the updating values.

In an example, the amplifier comprises a memory including a setup file which is configured to be updated by the control unit, based on the setup data. The setup data received may comprise a signature to allow the control unit to perform a check on the digital signature. The setup data received may be encrypted to allow the control unit to decrypt them.

In an embodiment, the audio amplifier comprises a serial number uniquely assigned to the audio amplifier and accessible to the memory, and the setup file comprises the serial number, so as to allow the control unit to check that the serial number in the setup file matches the serial number in the amplifier.

For example, the setup data are transmitted by NFC technology from a mobile device enabled to transfer data by NFC technology to an NFC data exchange device contained in the audio amplifier. The setup data may be transmitted through an Internet connecting channel, where the Internet connecting channel is protected and included in the audio amplifier. The setup data may be transmitted through a connecting channel between the audio amplifier and a local computer.

In an example, the method comprises a step of logging in to an authentication platform by a user (for example, an application on a mobile device, a web platform or a proprietary software program installed in a local computer). The method may comprise a step of validating the user. The method may comprise a step, performed by a preferably remote server, of generating the setup data, according to the result of the validation (that is, a step of retrieving the setup data from a remote database via a preferably remote server).

In an example, the method comprises steps, performed by the control unit through a Safety Operating Area (SoA) protection system, of limiting an output power from the audio amplifier, and/or of limiting an input current delivered to the audio amplifier, based on the setup parameters received.

In an embodiment, the method comprises a step of detecting, performed by a sensor system. For example, there may be a step, performed by an output current sensor of the sensor system, of detecting a value of output current delivered by the audio amplifier. There may be a step, performed by an output voltage sensor, of detecting a value of output voltage delivered by the audio amplifier. There may be a step, performed by a power supply current sensor, of detecting a value of input current to the audio amplifier. The method may comprise a step, at the control unit, of receiving the values detected by the sensor system and a step of checking that the detected values match the set updating values. The method may comprise a step of controlling an output power and/or an output current, based on the check that the values match.

This invention is based on a modular, parameterizable software structure to determine the capabilities, that is, the characteristics, of the audio amplifier. In particular, the software embedded in the amplifier is structured through separate processes which can be run only if the functions related to the process have been purchased by a user. The processes can also be parameterized so as to limit the capabilities of the machine. For example, the software limits the output power as a function of the characteristics purchased by the user (an end customer, a distributor, a reseller). The hardware is sized to deliver the maximum capabilities. The output power is limited by the software in accordance with options purchased. In order to ensure that the amplifier uses only the functions effectively purchased, a setup file that is digitally signed is used. That way, the amplifier software can check the authenticity of the file and prevent the settings from being loaded if the signature is not valid or if the file has been modified.

### BRIEF DESCRIPTION OF THE DRAWINGS

This and other features will become more apparent from the following description of a preferred embodiment, illustrated by way of non-limiting example in the accompanying drawings, in which:

FIGS. 1-4 illustrate the modes of connection and data transmission to vary the settings of an audio amplifier 1, according to one or more aspects of this description;

FIGS. 5A and 5B illustrate an audio amplifier 1 according to one or more aspects of this disclosure;

FIG. 6 illustrates an example of steps to vary the settings of an audio amplifier 1, according to one or more aspects of this disclosure.

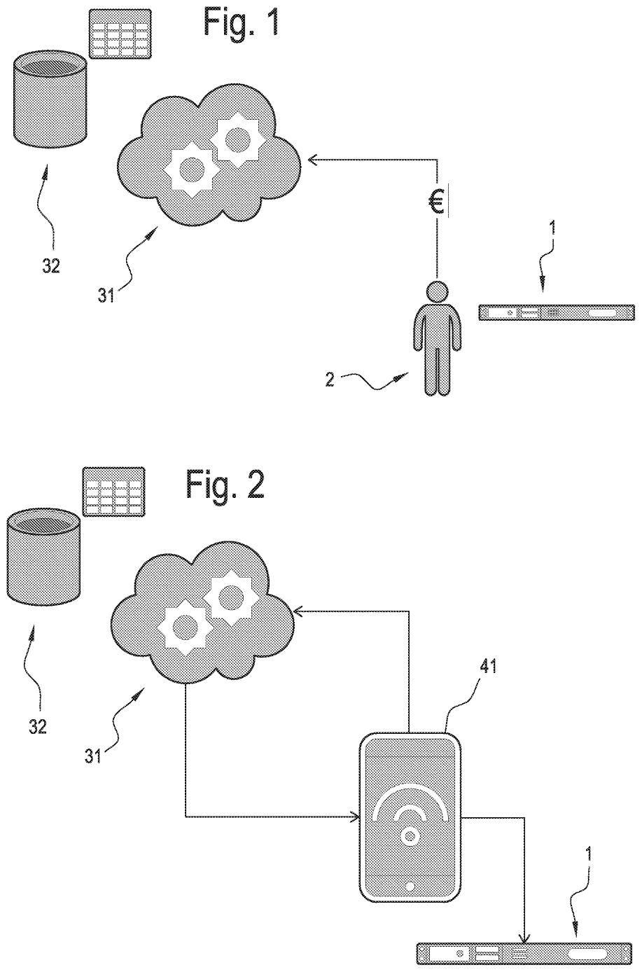

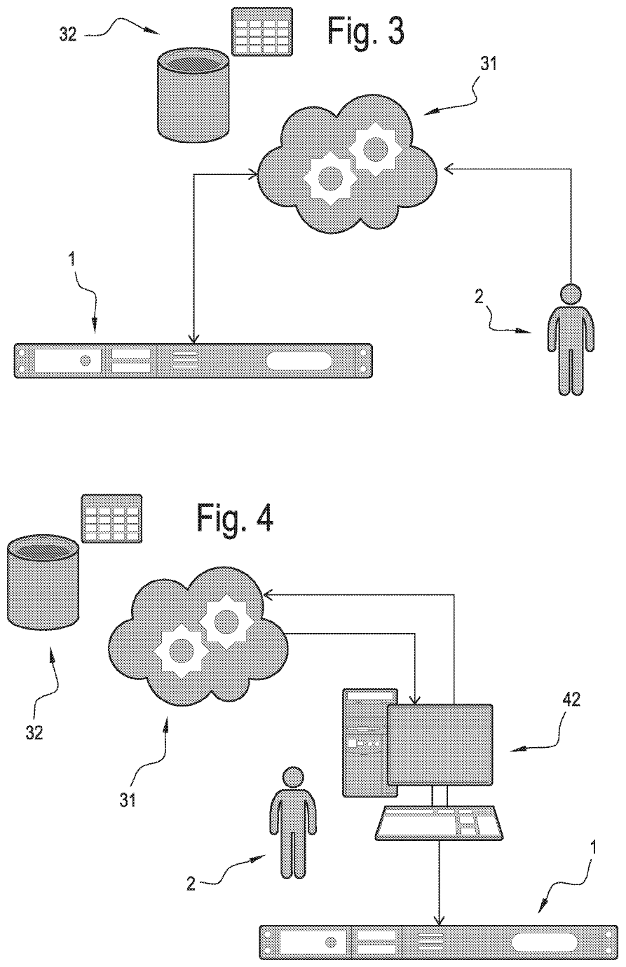

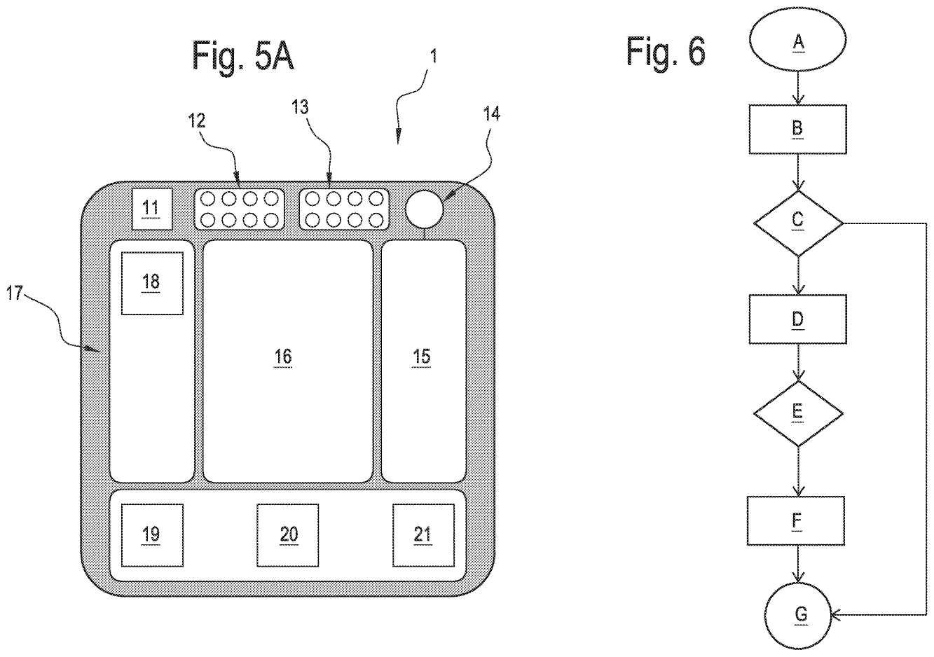

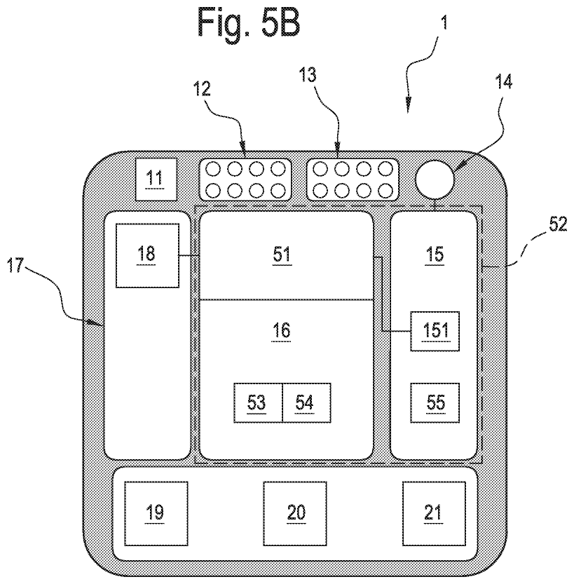

### DETAILED DESCRIPTION OF PREFERRED EMBODIMENTS OF THE INVENTION

The numeral 1 in the drawings denotes an audio power amplifier. The audio power amplifier 1 comprises an Ethernet connector 11 to make a channel for connection to the Internet or to a local network. The amplifier 1 comprises a plurality of output channels 12 and a plurality of input channels 13 so as to define a multi-channel amplifier 1. The amplifier 1 comprises a main power connector 14 and a portion 15 dedicated to the electrical power supply of the audio amplifier 1. The audio amplifier 1 comprises an electronic card 16 dedicated to the electronic power circuitry and an electronic card 17 dedicated to the electronic signalling circuitry. The amplifier 1 comprises a control unit 18, a memory 19, an NFC data exchange device 20 and a display 21.

The control unit 18 comprises instructions including setup parameters and configured to allow defining capabilities and functions of the amplifier itself. In particular, the instructions allow enabling or disabling one or more functions of the amplifier 1, for example, enabling and/or disabling digital audio-over-IP output channels from the amplifier and/or digital audio-over-IP input channels, to define a number of digital output and/or input channels and to define a type of encoding of the digital output and/or input channels (for example, Dante®, AES67®, Milan® and others), enabling and/or disabling one or more audio signal processing blocks (or algorithms), to define a number of audio signal processing blocks and/or a sequence of executing the audio signal processing blocks, a capacity of the signal processing blocks and others.

The instructions are also configured to allow setting a size of one or more capabilities of the amplifier 1 (for example, a size of the maximum power of the audio output signal from the amplifier 1, a capacity of a signal processing block and others).

The audio amplifier 1 defines a Safety Operating Area (SoA) protection system. Through the SoA protection system, the control unit 18 is programmed to limit the output power for each channel of the audio amplifier 1 and to limit the input current to the power unit 14, based on the updating data received.

The audio amplifier 1 comprises an SoA controller 51, configured to implement the SoA protection system. The SoA controller 51 is programmed to set the characteristics of the audio amplifier 1. In particular, the SoA controller 51 is programmed to define the values of output power delivered by the audio amplifier 1 and/or to define the values of input current delivered to the audio amplifier 1.

The portion 15 dedicated to the electrical power supply includes a controller 151 of the power unit, connected to the SoA controller 51 so as to communicate therewith and to adjust the absorption of current on the power unit 14 (based on the setup data).

The electronic card 16 dedicated to the power circuitry and the portion 15 dedicated to the electric power supply may be located on a shared electronic card 52 (to carry out the power supply function and the power amplifying function); the SoA controller 51 may also be located on the shared electronic card 52.

The audio amplifier 1 comprises a sensor system. The sensor system comprises an output current sensor 53 and an output voltage sensor 54, configured to detect, for each channel, an output current value and an output voltage value, respectively. The output current sensor 53 and the output voltage sensor 54 may be located on the electronic card 16 dedicated to the power circuitry. The audio amplifier 1 comprises a power supply current sensor 55, configured to detect a value of power supply current and located on the portion 15 dedicated to the electrical power supply. The sensor system may comprise a temperature sensor, configured to detect a temperature value. The control unit 18 is programmed to receive the values detected by the sensor system, so as to check that the detected values match the set updating values.

The audio power amplifier 1 allows a user 2 (a distributor or an end user) to vary the settings of the audio amplifier 1, that is, to define the capabilities and functions of the audio amplifier 1.

Operatively, the user 2 enters the credentials needed to log in to an authentication platform (for example, an application installed in a mobile device 41, a web platform or a proprietary software program installed in a local computer 42). Next, the user 2 is validated by checking the credentials, present in a remote server, comprising a cloud service 31 and an external database 32. In particular, the remote server may ask for the credentials of the user 2 to be validated by the cloud service 31, where the credentials of the user 2 are stored in the external database 32. Once the user 2 has been validated by the remote server, the user 2 is correctly identified and enabled to purchase capabilities and/or functions of the audio amplifier 1. For example, the user 2 may choose a maximum output power, a number of digital output and/or input channels and other settings. Following the selections made by the user 2, the remote server asks the cloud service 31 to check the amplifiers 1 possessed by the user 2 and, for each amplifier 1 possessed by the user 2, to indicate which settings can be purchased. When purchasing is complete, the remote server generates setup data (based on the capabilities and/or functions purchased). Preferably, the setup data are contained in a setup file. The setup data represent updating values for the setup parameters.

Generally speaking, the setup data are transmitted to the control unit 18, programmed to update the setting of the characteristics of the audio amplifier 1 according to the updating values. The setup data (individually or contained in the setup file) can be transmitted to the control unit 18 by different methods.

One method involves using the NFC data exchange device 20 present on the audio amplifier 1 via the mobile device 21 enabled to transfer data using NFC technology. In particular, the user 2 places the mobile device 41 close to the NFC data exchange device 20 so as to transfer the setup data to the amplifier 1.

In another method, the Internet connection channel of the audio amplifier 1 is used. In this case, the audio amplifier 1 can connect to the remote server through the Internet connection channel to receive the setup data.

In another method, a channel connecting the audio amplifier 1 to a local computer 42 is used; transmission of the setup data between the remote server and the amplifier occurs through the local computer 42, which has proprietary software installed in it, or through a web platform to the local computer 42.

Thus, the user 2 enters credentials to log in to the authenticating platform and, after being validated by the remote server, the remote server retrieves the setup data (previously purchased by the user 2) and transmits them to the audio amplifier 1 according to one or more of the methods described (FIG. 6, step A). The setup data are copied to the memory 19 of the audio amplifier 1 (FIG. 6, step B). The control unit 18 performs a check on a digital signature associated with the setup data received (FIG. 6, step C). If the result of the check is negative, the control unit 18 interrupts the process and does not update the settings of the audio amplifier 1 (FIG. 6, step G). If the result of the check is positive, the control unit 18 extracts a serial number from the setup data (FIG. 6, step D) and compares it with a serial number uniquely assigned to the audio amplifier 1 (FIG. 6, step E). If the result of the comparison is negative, the control unit 18 interrupts the process and does not update the settings of the audio amplifier 1 (FIG. 6, step G). If the result of the comparison is positive, the control unit 18 updates the settings of the audio amplifier 1 (FIG. 6, step F).

Table 1 below represents an example of a mode of interaction between the user 2, the remote server, the cloud service 31 and the external database 32 during a step of checking the options available to the user 2 and purchasing the options for the audio amplifiers 1 available to the user 2.

Table 2 below represents an example of a mode of interaction between the audio amplifier 1, the user 2, the remote server, the cloud service 31 and the external database 32 during a step in which the options purchased by the user 2 are activated by the user 2 by NFC data transfer.

1. An audio power amplifier, defining a plurality of characteristics pertaining to corresponding capabilities and functions of the audio amplifier itself and comprising a control unit which includes instructions,
wherein the instructions include setup parameters and wherein the control unit is programmed for:
setting the characteristics of the plurality of characteristics according to setup parameter values;
receiving setup data, representing updating values for the plurality of setup parameters and for updating the setting of the plurality of characteristics according to the updating values.

2. The audio amplifier according to claim 1, wherein the control unit
comprises a memory including a setup file, and
is programmed to update the setup file based on the setup data received.

3. The audio amplifier according to claim 2, wherein the setup file comprises a digital signature and wherein the control unit is programmed to perform a check on the digital signature.

4. The audio amplifier according to claim 2, comprising a serial number uniquely assigned to the amplifier and accessible to the memory, and wherein the setup file comprises the serial number, the control unit being programmed to check that the serial number in the setup file matches the serial number of the audio amplifier.

5. The audio amplifier according to claim 1, comprising an NFC data exchange device, and wherein the control unit is programmed to receive the setup data through the data exchange device from a mobile device enabled to transfer data by NFC technology.

6. The audio amplifier according to claim 1, comprising an Internet connecting channel, wherein the control unit is programmed to receive the setup file in encrypted form through the Internet connecting channel, and to decrypt the setup file.

7. The audio amplifier according to claim 1, wherein the plurality of characteristics comprises one or more of the items from the following list:
a maximum power of the audio output signal from the amplifier;
number of digital audio-over-IP input channels to the audio amplifier;
number of digital audio-over-IP output channels from the audio amplifier;
type of encryption of digital audio-over-IP input channels;
type of encryption of digital audio-over-IP output channels;
type of signal processing blocks of the audio amplifier;
capacity of the signal processing blocks;
application functions, for example, the playing of audio files.

8. The audio amplifier according to claim 1, wherein the control unit has a clock and is programmed to set the characteristics permanently or for a defined time interval according to instructions contained in the setup file.

9. The audio amplifier according to claim 1, wherein the instructions are designed to enable or disable one or more of the plurality of characteristics, or to set a size of one or more of the plurality of characteristics, based on the setup data.

10. The audio amplifier according to claim 1, comprising a Safety Operating Area (SoA) protection system, wherein the control unit, through the SoA protection system, is programmed to limit an output power delivered by the audio amplifier and to limit an input current delivered to the audio amplifier, based on the setup parameters received.

11. The audio amplifier according to claim 10, comprising a sensor system including at least one of the following elements:
an output current sensor, configured to detect a value of output current delivered by the audio amplifier;
an output voltage sensor, configured to detect a value of output voltage delivered by the audio amplifier;
a power supply current sensor, configured to detect a value of input current delivered to the audio amplifier,
wherein the control unit is programmed to receive the values detected by the sensor system and to check that the detected values match the set updating values.

12. A method for amplifying an audio signal through an audio power amplifier, the audio amplifier defining a plurality of characteristics pertaining to corresponding capabilities and functions of the audio amplifier itself and comprising a control unit, the control unit including instructions,
wherein the instructions include setup parameters, the method comprising the following steps, performed by the control unit:
setting the plurality of characteristics according to setup parameter values;
receiving setup data, representing updating values for the plurality of setup parameters and updating the setting of the plurality of characteristics according to the updating values.

13. A method for varying settings of an audio amplifier, the audio amplifier defining a plurality of characteristics pertaining to corresponding capabilities and functions of the audio amplifier itself and comprising a control unit, the control unit including instructions,
wherein the instructions comprise setup parameters, the method comprising a step of transmitting setup data, representing updating values for the setup parameters, the setup data being intended to be received and processed by the control unit to update the setting of the plurality of characteristics according to the updating values.

14. The method according to claim 13, wherein the audio amplifier comprises a memory including a setup file configured to be updated by the control unit based on the setup data, wherein at least one of the following conditions is true:
i) the setup data received comprise a signature to allow the control unit to perform a check on the digital signature;
ii) the setup data received are encrypted to allow the control unit to decrypt them.

15. The method according to claim 14, wherein the audio amplifier comprises a serial number uniquely assigned to the amplifier and accessible to the memory, and wherein the setup file comprises the serial number, so as to allow the control unit to check that the serial number in the setup file matches the serial number of the audio amplifier.

16. The method according to claim 13, wherein at least one of the following conditions is true:
i) the setup data are transmitted by NFC technology from a mobile device enabled to transfer data by NFC technology to an NFC data exchange device contained in the audio amplifier;
ii) the setup data are transmitted through an Internet connecting channel, wherein the Internet connecting channel is protected and included in the audio amplifier;
iii) the setup data are transmitted through a connecting channel between the audio amplifier and a local computer.

17. The method according to claim 13, comprising the following steps:
logging in to an authentication platform by a user;
validating the user;
generating the setup data via a server, according to the result of the validation.

18. The method according to claim 13, comprising the following steps, carried out by the control unit through a Safety Operating Area (SoA) protection system:
limiting an output power delivered by the audio amplifier, and
limiting an input current delivered to the audio amplifier,
based on the setup parameters received.

19. The method according to claim 18, comprising the following steps, carried out by a sensor system:
via an output current sensor of the sensor system, detecting a value of output current delivered by the audio amplifier,
via an output voltage sensor, detecting a value of output voltage delivered by the audio amplifier,
via a power supply current sensor, detecting a value of input current delivered to the audio amplifier,
the method comprising a step, at the control unit, of receiving the values detected by the sensor system and a step of checking that the detected values match the set updating values.
